(19) United States
(12) Patent Application Publication
(10) Pub. No.: US 2026/0164325 A1
(43) Pub. Date: Jun. 11, 2026

(54) SYSTEMS AND METHODS FOR NETWORK NODE SWITCHING

(71) Applicant: T-MOBILE INNOVATIONS LLC, Overland Park, KS (US)

(72) Inventor: Jasinder P. SINGH, Olathe, KS (US)

(21) Appl. No.: 18/969,475

(22) Filed: Dec. 5, 2024

(51) Int. Cl. H04W 36/14; H04L 41/40; H04M 15/00; H04W 36/00

(52) U.S. Cl. CPC H04W 36/14; H04L 41/40; H04M 15/66; H04W 36/00222

(57) ABSTRACT

Systems, methods and devices are provided for network node switching. The method includes determining, by a wireless network communicatively connected to a wireless device, a data network name (DNN) associated with a network slice serving the wireless device and updating, by the wireless network, a policy and charging rules function (PCRF) by mapping the DNN to an access point name (APN) for the network slice serving the wireless device.

### TECHNICAL BACKGROUND

Wireless devices, or user equipment, often are capable of connecting to different types of access nodes, such as an evolved NodeB (eNodeB), for LTE/4G, and a next generation Node B (gNodeB) for 5G. For connections to a 5G network, a network slicing feature is available. Network slicing allows a single network to be divided into multiple slices. Each slice can be configured and used in its own way. For example, a network slice may be established and configured for a Mobile Virtual Network Operator (MVNO) to lease from a larger cellular service provider to a small cellular service provider. As another example, network slices may be configured for different Quality of Service (QoS) levels such as a network slice for video streaming with its high bandwidth requirements and another for voice over IP (VOIP) with its low latency but lower bandwidth requirements. However, network slicing is not available for older networks such as LTE networks.

### OVERVIEW

Exemplary embodiments described herein include systems, methods, and processing nodes for network node switching. An exemplary method includes determining, by a wireless network communicatively connected to a wireless device, a data network name (DNN) associated with a network slice serving the wireless device and updating, by the wireless network, a policy and charging rules function (PCRF) by mapping the DNN to an access point name (APN) for the network slice serving the wireless device.

Further exemplary embodiments include a system for network node switching. The system includes a computing device communicatively connected to a wireless network, wherein the computing device includes at least one processor configured to determine a DNN associated with a network slice serving the wireless device and update a PCRF by mapping the DNN to an APN for the network slice serving the wireless device.

In yet a further exemplary embodiment, a non-transitory computer readable medium is provided. The non-transitory computer-readable medium stores instructions, when executed by a processor, configuring the processor to determine a DNN associated with a network slice serving the wireless device and update a PCRF by mapping the DNN to an APN for the network slice serving the wireless device.

### BRIEF DESCRIPTION OF THE DRAWINGS

These and other more detailed and specific features of various embodiments are more fully disclosed in the following description, reference being had to the accompanying drawings, in which:

FIG. 1 illustrates an exemplary system for wireless communication in accordance with various aspects of the present disclosure;

FIG. 2 illustrates an exemplary process flow for network node switching;

FIG. 3 illustrates an example of a computing device in accordance with aspects of this disclosure; and

FIG. 4 illustrates an exemplary processing node in accordance with various aspects of the present disclosure.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In accordance with various aspects of the present disclosure, a 5G core network provides network slices to allow for many virtualized networks to be provided on the hardware architecture of the cellular network operator. One use of network slicing is to provide different levels of Quality of Service (QoS) depending on the needs of the wireless devices using the network slices and the needs of the network operator providing them. Network slices can be created and configured for many different levels of QoS. For example, a network slice for video streaming requires high bandwidth and low latency. As another example, a network slice for voice calls would require lower bandwidth and tolerate higher latency than video calls. Each network slice may be created with specific parameters. Some of these parameters control the QoS for the network slice. These parameters control things such as data rates, latency, reliability, and traffic prioritization. However, network slicing is not available for LTE connections. The LTE core network is not aware of network slices or their parameters.

LTE connections manage QoS differently. The parameters managing QoS for LTE connections include Guaranteed Bit Rate (GBR), priority handling, packet error loss rate, and packet delay budget (PDB). A device using a network slice may need to switch from a 5G connection to an LTE, causing the slice to be lost.

To alleviate this problem, the 5G wireless network that is currently using a network slice may update the LTE core network with information associated with the network slice by updating a policy and charging rules function (PCRF) of the LTE network with a data network name (DNN) associated with the network slice. For example, the wireless device may be using a network slice configured for video calling that has high bandwidth and low latency. When that wireless device migrates to an LTE connection, it can utilize the QoS parameters of the network slice that it is currently using. The Mobility Management Entity (MME) of the LTE core network can use this information to create a performance profile for the LTE connection that it sets up for the wireless device. The MME can set parameters for packet scheduling, GBR and/or assign a specific QCI. For example, a GBR of 10 Mbps can be set or packets can be given a high priority for packet scheduling. Assigning a specific QCI can be done by selecting an appropriate QCI from the list of QCIs supported by the LTE network. The MME can be configured to analyze the QoS parameters from the wireless device and select a QCI that most closely approximates the QoS parameters assigned to the network slice servicing the wireless device. In the video call example above, the MME may choose to use QCI 2 as defined by 3GPP and discussed above, for example, and set the parameters for the LTE connection in accordance with the parameters outlined in QCI 2. The MME may establish the LTE connection and then wait for the wireless device to drop its 5G connection and connect to it.

In some instances, an access and mobility management (AMF), of the 5G network, may redirect the device to reconnect to the 5G network. For example, the network may initiate a handover to new radio (HO to NR) based on the detecting that the device is connected to a LTE/4G network. In an example, network may redirect the wireless device to NR based on the detection. In an example, the network may detach the device based in the detection such that the wireless device will reattach to 5GNR.

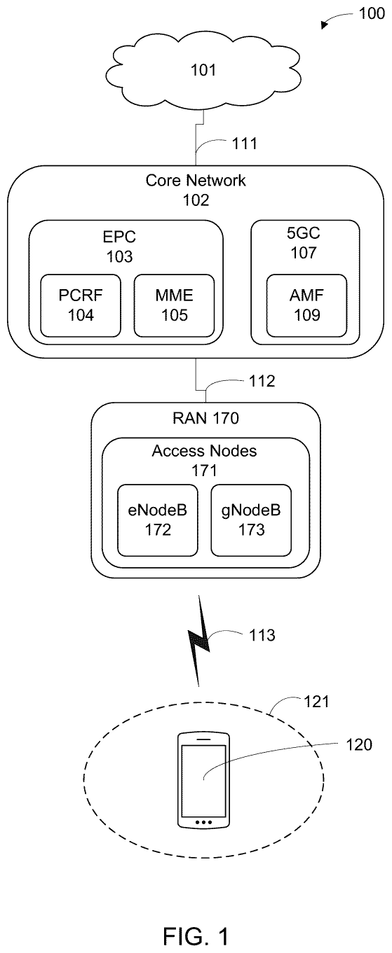

These and other examples will be described in greater detail below in relation to FIGS. 1-4.

FIG. 1 depicts an exemplary system 100 for network node switching. System 100 includes a communication network 101, a core network 102, a radio access network (RAN) 170 and at least one wireless device 120.

Core network 102 is connected to communication network 101 over communication link 111. Core network 102 includes an evolved packet core (EPC) 103 and a 5G core (5GC) 107. EPC 103 as used herein are core network components used for managing data for LTE, 4G, and/or other networks. 5GC 107 as used herein are core network components used for managing data for 5G networks. In embodiments, core network 102 may be configured to detect that a device, such as wireless device 120, being served by a network slice is connected to an LTE/4G network. It should be noted that core network 102 may include other components used for managing data for networks not described herein, such as a satellite core network.

In embodiments, EPC 103 includes a policy and charging rules function (PCRF) 104 and a mobility management entity (MME) 105. PCRF 104 is responsible for policy enforcement and quality of service (QoS) management. MME 105 is responsible for handling connection and mobility management tasks on an LTE/4G network. In some embodiments, PCRF 104 is configured to be updated by mapping a data network name (DNN) associated with a network slice serving a device, such as wireless device 120, to an access point name (APN) for the network slice serving the wireless device. For example, when MME 105 detects that the device being served by the network slice is connected to the LTE network, the MME 105 may communicate with PCRF 104 to adjust policy rules and QoS parameters and redirect the session established for the network slice using the APN, mapped to the DNN at the PCRF 104. In some embodiments, PCRF 104 may be updated as to update a subscription expiration for the network slice. For example, a slice may be only valid during a validity period, such as set start and end date, or may expire after a usage limit, such as a data cap for the slice. If the slice is no longer valid, PCRF 104 may be update to remove the parameters associated with that slice. It should be noted that EPC 103 may include other components not described herein.

In embodiments, 5GC 107 includes an access and mobility function (AMF) 109. The AMF 109 receives connection and session related information from the wireless devices 120 and is responsible for handling connection and mobility management tasks on a 5G network. In an embodiment, AMF 109 may be used for redirecting a device, such as wireless device 120, to a 5G network. For example, if a device being served by a network slice is switched to LTE, such as due to loss of connectivity, AMF 109 may reestablish the connection once the device is connectable to the 5G network. In some instances, core network 102 may be configured to initiate a handover to new radio (HO to NR) once the device, such as wireless device 120, is connectable to the 5G network. In embodiments, core network 102 may be configured to redirect a device, such as wireless device 120, to 5G new radio (5GNR) once the device is connectable to the 5G network.

The RAN 170 includes access nodes 171. In embodiments, the access nodes 171 include an evolved Node B (eNodeB) 172 and a next generation Node B (gNodeB) 173. As used herein, eNode B 172 is a base station in LTE/4G networks used for connecting a user device, such as wireless device 120, to core network 102. GNodeB 173, as used herein, is a base station in 5G networks and/or other networks used for connecting a user device to core network 102. The gNodeB 173 may include, for example, centralized units (CUs) and distributed units (DUs).

RAN 170 is connected to core network 102 over communication link 112. RAN 170 may include other devices and additional nodes not described herein. For example, RAN 170 may include devices used for forwarding media files over IP from wireless device 120 to core network 102.

System 100 also includes a wireless device 120. In embodiments, system 100 may include multiple wireless devices. Wireless device 120 is configured to operate in one or more coverage areas 121. Wireless device 120 may be an end-user wireless device. Wireless device 120 may include any device configured to send and receive data. In embodiments, wireless device 120 communicates with RAN 170 over communication link 113. Examples of communication link 113 may include 5G network, 4G LTE, and the like.

Communication network 101 may be wired and/or wireless communication network. In embodiments, communication network 101 may include processing nodes, routers, gateways, physical and/or wireless data links for carrying data among various network elements, including combinations thereof. In embodiments, communication network 101 may include a local area network, a wide area network, an inter-network, such as the internet, and the like. Communication network 101 may be capable of carrying data, such as, for example, to support multimedia files, and data communications by wireless device 120. Wireless network protocols can include multimedia broadcast multicast service (MBMS), code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE), 6G and/or non-terrestrial networks. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), Asynchronous Transfer Mode (ATM), and/or so forth. Communication network 101 may also include additional base stations, controller nodes, telephony switches, internet routers, network gateways, computer systems, communication links, or some other type of communication equipment, and combinations thereof.

The core network 102 includes core network functions and elements. The core network 102 may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QoS) handling, etc. The control plane functions may include, for example, a network slice selection function (NSSF), a network exposure function (NEF), a network repository function (NRF), a policy control function (PCF), a unified data management (UDM) function, an application function (AF), an AMF, such as AMF 109, an authentication server function (AUSF), and a session management function (SMF). Additional or fewer control plane functions may also be included. The AMF receives connection and session related information from the wireless devices 120 and is responsible for handling connection and mobility management tasks. The SMF is primarily responsible for creating, updating, and removing sessions and managing session context. The UDM function provides services to other core functions, such as the AMF 109, SMF, and NEF. The UDM may function as a stateful message store, holding information in local memory. The NSSF can be used by AMF 109 to assist with the selection of network slice instances that will serve a particular device. Further, the NEF provides a mechanism for securely exposing services and features of the core network.

In instances, the UDM may include a mapping of DNNs to network slice selection assistance information (nSSAI) associated with a wireless device 120. nSSAI includes a set of single nSSAI(S-nSSAI). Each S-nSSAI may include a slice/service type and a slice differentiator (SD). For example, AMF 109 may query UDM for S-nSSAIs associated with a DNN. In an example, AMF 109 may use NSSF for selecting a S-nSSAI based on additional requirements, such as regional availability. In some embodiments, UDM may detect a subscription expiration for a slice, such a validity period based slice, and notify AMF 109 of the expiration. Once notified, AMF 109 updates nSSAI by removing expired S-nSSAIs.

Although one core network 102 is shown, multiple core networks 102 may be utilized. Alternatively, the single core network 102 may include a distributed, cloud-native, converged core gateway. Thus, the converged core gateway could connect EPC 103 to 5GC 107 network.

Communication links 111 and 112 can use various communication media, such as air, space, metal, optical fiber, or some other signal propagation path, including combinations thereof. Communication links 111 and 112 can be wired or wireless and use various communication protocols such as Internet, Internet protocol (IP), local-area network (LAN), S1, optical networking, hybrid fiber coax (HFC), telephony, T1, or some other communication format—including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 111 and 112 can be direct links or might include various equipment, intermediate components, systems, and networks, such as a cell site router, etc. Communication links 111 and 112 may comprise many different signals sharing the same link.

In embodiments, RAN 170 may include various access network systems and devices such as access nodes 171. The RAN 170 is disposed between the core network 102 and the end-user wireless device 120. Components of the RAN 170 may communicate directly with the core network 102 and others may communicate directly with the end user wireless device 120. The RAN 170 may provide services from the core network 102 to the end-user wireless device 120. It is understood that the disclosed technology may also be applied to communication between an end-user wireless device and other network resources, such as relay nodes, controller nodes, antennas, etc. Further, multiple access nodes may be utilized. For example, some wireless devices may communicate with eNodeB 172 and others may communicate with gNodeB 173.

In additional embodiments, access nodes 171 may comprise two co-located cells, or antenna/transceiver combinations that are mounted on the same structure. Alternatively, access nodes 171 may comprise a short range, low power, small-cell access node such as a microcell access node, a picocell access node, a femtocell access node, and/or a home eNodeB device. As will be further described below, functionality for network node switching may be included within the access nodes 171. Access nodes 171 can be configured to deploy one or more different carriers, utilizing one or more RATs. For example, gNodeB 173 may support NR and an eNodeB 172 may provide LTE coverage. It would be evident to one of ordinary skill in the art, in light of this disclosure, the many other combinations of access nodes and carriers that could be deployed.

The access node 171 may include a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless device 120 may include any wireless device included in a wireless network. For example, the term “wireless device” may include a relay node, which may communicate with an access node. The term “wireless device” may also include an end-user wireless device, which may communicate with access nodes 171 through the relay node. The term “wireless device” may further include an end-user wireless device that communicates with the access node 171 directly without being relayed by a relay node.

Wireless device 120 may be any device, system, combination of devices, or other such communication platform capable of communicating wirelessly with access nodes 171 using one or more frequency bands and wireless carriers deployed therefrom. Each of wireless devices 120, may be, for example, a mobile phone, a wireless phone, a wireless modem, a personal digital assistant (PDA), a voice over internet protocol (VoIP) phone, a voice over packet (VOP) phone, or a soft phone, an internet of things (IoT) device, as well as other types of devices or systems that can send and receive audio or data. The wireless device 120 may be or include high power wireless devices or standard power wireless devices. Other types of communication platforms are possible.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork, such as the internet. System 100 may be capable of communicating signals and carrying data, for example, to support voice, push-to-talk, broadcast video, and data communications by end-user wireless device 120. System 100 may include additional base stations, controller nodes, telephony switches, internet routers, network gateways, computer systems, communication links, or other type of communication equipment, and combinations thereof.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between the RAN 170 and the core network 102.

The methods, systems, devices, networks, access nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including access nodes, controller nodes, and gateway nodes described herein.

The operations for network node switching may be implemented as computer-readable instructions or methods, and processing nodes on the network and/or computing device, such as end user wireless device, for executing the instructions or methods. The processing node may include a processor included in the access node or a processor included in any controller node in the wireless network that is coupled to the access node. The computing device may include at least a processor and a memory with instructions configuring the processor to execute instructions.

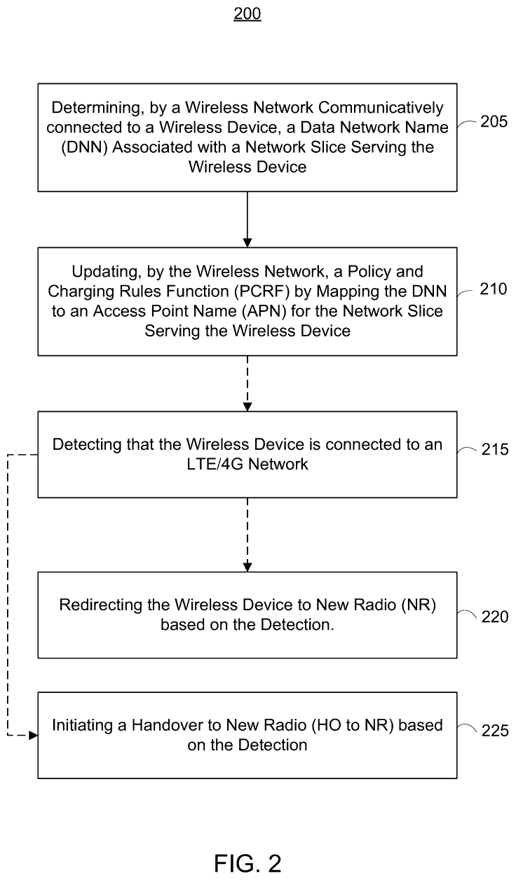

With reference to FIG. 2, a flow diagram of method 200 for network node switching is presented. Method 200 includes, at step 205, determining, by a wireless network communicatively connected to a wireless device, a DNN associated with a network slice serving the wireless device. In instances, AMF may query a UDM for a S-nSSAI for the network slice associated with the DNN.

At step 210, method 200 includes updating, by the wireless network, a PCRF by mapping the DNN to an APN for the network slice serving the wireless device. In embodiments, updating the PCRF may include using a MME. In some embodiments, method 200 may further include updating the PCRF to update with a subscription expiration for the network slice. The PCRF and MME may be the same as PCRF 104 and MME 105, respectively, described in reference to FIG. 1.

In embodiments, method 200 may include, at step 215, detecting that the wireless device is connected to an LTE/4G network. In embodiments, method 200 may include, at step 220, redirecting the wireless device to 5G new radio (5G NR) based on the detection. In further embodiments, an AMF, such as AMF 109, may redirect the wireless device. In some embodiments, method 200 may include, at step 225, initiating a handover to new radio (HO to NR) based on the detection. In embodiments, method 200 may include detaching the wireless device based on the detection such that the wireless device will reattach to NR. It should be noted that the steps above are only performed if a 5G NR network is available for connection.

In some embodiments, methods 200 may include additional steps or operations. Furthermore, the methods may include steps shown in each of the other methods. As one of ordinary skill in the art would understand, method 200 may be integrated in any useful manner and the steps may be performed in any useful sequence.

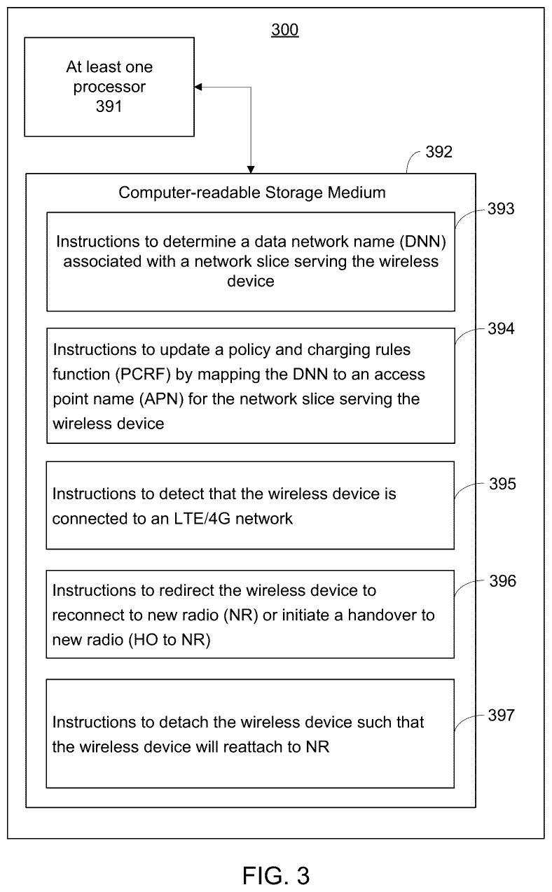

Now referring to FIG. 3, an example computing device 300 is presented. In embodiments, computing device 300 may include a node device, such as devices operating within communication network described in reference to FIG. 1. In this example, computing device 300 includes at least one processor 391 communicably coupled to a computer-readable storage medium 392. The at least one processor 391 may include a microprocessor, a microcontroller, one or more central processing unit (CPU) cores, an application-specific integrated circuit (ASIC), one or more graphical processing unit (GPU) cores, a field programmable gate array (FPGA), and/or any other hardware device suitable for retrieval and execution of instructions from computer-readable storage medium 392. In instances, at least one processor 391 may include electronic circuitry for performing instructions described in this disclosure.

In instances, computer-readable storage medium 392 may be any medium suitable for storing executable instructions. In examples, without limitation, computer-readable storage medium 392 may include read-only memory (ROM), random-access memory (RAM), erasable electrically programmable ROM (EEPROM), Solid State Drive (SSD), optical disc, and the like. Computer-readable medium storage 392 may be disposed within computing device 300. In embodiments, computer-readable storage medium 392 may be external, and communicably connected, to computing device 300. The instruction stored on computer-readable storage medium may be used to implement method steps described in reference to FIG. 2.

In this example, computer-readable storage medium 392 is encoded with a set of instructions 393 and 394. In some embodiments, computer-readable storage medium 392 may further be encoded with instructions 395, 396 and/or other sets of instructions. In embodiments, executable instructions included in each block may be included in different blocks shown and blocks not shown.

Instruction 393, when executed by at least one processor 391, configures the at least one processor 391 to determine a DNN associated with a network slice serving the wireless device.

Instruction 394, when executed by at least one processor 691, configures the at least one processor 691 to update a PCRF by mapping the DNN to an APN for the network slice serving the wireless device.

In embodiments, computer-readable storage medium 392 may include instruction 395 configuring the at least one processor 391 to detect that the wireless device is connected to an LTE/4G network. In embodiments, computer-readable storage medium 392 may include instruction 396 configuring the at least one processor 391 to redirect the wireless device to reconnect to 5G new radio (5GNR) or initiate a handover to new radio (HO to NR), based on detecting that the wireless device is connected to an LTE/4G network. In embodiments, computer-readable storage medium 392 may include instruction 397 configuring the at least one processor 391 to detach the wireless device based on detecting that the wireless device is connected to an LTE/4G network such that the wireless device will reattach to NR.

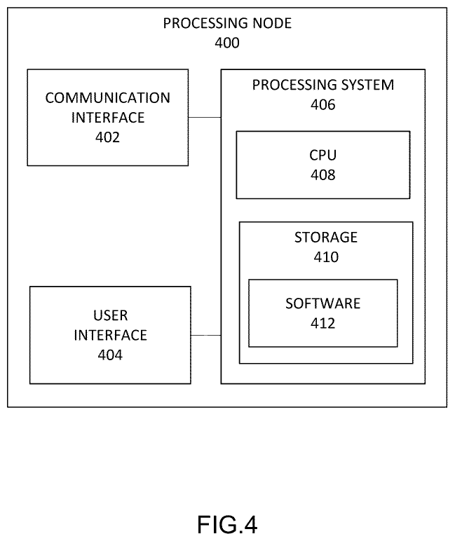

Now referring to FIG. 4, an example processing node 400, which may be configured to perform the methods and operations disclosed herein for network energy reduction. The processing node 400 includes a communication interface 402, user interface 404, and processing system 406 in communication with communication interface 402 and user interface 404. Communication interface 402 may include hardware components, such as network communication ports, devices, routers, wires, antenna, transceivers, etc. User interface 404 may include hardware components, such as touch screens, buttons, displays, speakers, etc.

Processing system 406 includes a central processing unit (CPU) or processor 408 and storage 410. Storage 410 may include a disk drive, flash drive, memory circuitry, or other memory device including, for example, a buffer. Storage 410 can store software 412 which is used in the operation of the processing node 400. Software 412 may include computer programs, firmware, or some other form of machine-readable instructions, including an operating system, utilities, drivers, network interfaces, applications, or some other type of software. Processing system 406 may include a processor 408 and other circuitry to retrieve and execute software 412 from storage 410, which may be internal or external to the processing system 406. Processing node 400 may further include other components such as a power management unit, a control interface unit, etc., which are omitted for clarity. Communication interface 402 permits processing node 400 to communicate with other network elements. User interface 404 permits the configuration and control of the operation of processing node 400. Processing node 400 may be included in various elements of the wireless network including an access node, proxy call session control function (P-CSCF), gateway mobile location center (GMLC), radio resource control (RRC), inter-cell interference coordination (ICIC), medium access control (MAC), session border controller (SBC), and the like. In this example, software 412 may include the instructions described in reference to FIG. 3.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, the method comprising:
determining, by a wireless network communicatively connected to a wireless device, a data network name (DNN) associated with a network slice serving the wireless device; and
updating, by the wireless network, a policy and charging rules function (PCRF) by mapping the DNN to an access point name (APN) for the network slice serving the wireless device.

2. The method of claim 1, wherein updating the PCRF comprises using a mobility management entity (MME).

3. The method of claim 1, further comprising detecting that the wireless device connected to an LTE/4G network.

4. The method of claim 3, further comprising initiating a handover to new radio (HO to NR) based on the detection.

5. The method of claim 3, further comprising redirecting the wireless device to 5G new radio (5GNR) based on the detection.

6. The method of claim 5, wherein an access and mobility management function (AMF) redirects the wireless device.

7. The method of claim 3, further comprising detaching the wireless device based on the detection such that the wireless device will reattach to NR.

8. The method of claim 3, further comprising updating the PCRF to update with a subscription expiration for the network slice.

9. A system, the system comprising:
a wireless device connected to a network slice; and
a wireless network comprising at least one computing device communicatively connected to the wireless device, wherein the at least one computing device is configured to:
determine a data network name (DNN) associated with a network slice serving the wireless device; and
update a policy and charging rules function (PCRF) by mapping the DNN to an access point name (APN) for the network slice serving the wireless device.

10. The system of claim 9, wherein updating the PCRF comprises using a mobility management entity (MME).

11. The system of claim 9, wherein the at least one computing device is further configured to detect that the wireless device connected to an LTE/4G network.

12. The system of claim 11, wherein the at least one computing device is further configured to initiate a handover to new radio (HO to NR) based on the detection.

13. The system of claim 11, wherein the at least one computing device is further configured to redirect the wireless device to 5G new radio (5GNR) based on the detection.

14. The system of claim 13, wherein an access and mobility management function (AMF) redirects the wireless device.

15. The system of claim 11, wherein the at least one computing device is further configured to detach the wireless device based on the detection such that the wireless device will reattach to NR.

16. The system of claim 11, wherein the at least one computing device is further configured to update the PCRF to update a subscription expiration for the network slice.

17. A non-transitory computer-readable medium storing instructions, when executed by at least one processor, configuring the at least one processor to:
determine a data network name (DNN) associated with a network slice serving a wireless device; and
update a policy and charging rules function (PCRF) by mapping the DNN to an access point name (APN) for the network slice serving the wireless device.

18. The non-transitory computer-readable medium storing instructions of claim 17, wherein the at least one processor is further configured to detect that the wireless device is reconnected to an LTE/4G network.

19. The non-transitory computer-readable medium storing instructions of claim 18, wherein the at least one processor is further configured to, based on the detection, redirect the wireless device to reconnect to 5G new radio (NR) or initiate a handover to new radio (HO to NR).

20. The non-transitory computer-readable medium storing instructions of claim 18, wherein the at least one processor is further configured to detach the wireless device based on the detection such that the wireless device will reattach to NR.
